(19) United States
(12) Patent Application Publication
(10) Pub. No.: US 2007/0236442 A1
(43) Pub. Date: Oct. 11, 2007

(54) DISPLAY PANEL AND DISPLAY DEVICE HAVING THE SAME

(75) Inventors: Jae-Hyun CHO, Seoul (KR); Joon-Hak OH, Seoul (KR); Cheol-Woo PARK, Suwon-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/672,775

(22) Filed: Feb. 8, 2007

(30) Foreign Application Priority Data
Feb. 8, 2006 (KR) 2006-11981

(51) Int. Cl. G09G 3/36

(52) U.S. Cl. 345/100

(57) ABSTRACT

A display panel includes a plurality of gate lines, a plurality of source lines crossing the gate lines, a first integration gate line, a first pixel part, a second pixel part and a third pixel part. The first integration gate line integrates a (6K-5)-th gate line, a (6K-3)-th gate line and a (6K-1)-th gate line of the plurality of gate lines, where K is a natural number. The first pixel part, the second pixel part and the third pixel part are arranged in a same column. The first pixel part is driven by a first switching device electrically connected to the (6K-5)-th gate line and a (3K-2)-th source line of the plurality of source lines. The second pixel part is driven by a second switching device electrically connected to the (6K-3)-th gate line and a (3K-1)-th source line of the plurality of source lines. The third pixel part is driven by a third switching device electrically connected to the (6K-1)-th gate line and a 3K-th source line of the plurality of source lines.

This application claims priority to Korean Patent Application No. 2006-11981, filed on Feb. 8, 2006, and all the benefits accruing therefrom under 35 U.S.C. §119, the contents of which in its entirety are herein incorporated by reference.

### BACKGROUND OF THE INVENTION

1. Field of the Invention

The present invention relates to a display panel and a display device having the display panel. More particularly, the present invention relates to a display panel capable of improving a display quality and a display device having the display panel.

2. Description of the Related Art

Recently, a field sequential display device having a backlight assembly capable of separately generating a red light, a green light and a blue light has been developed. The field sequential display device sequentially generates the red, green and blue light in a predetermined time period so that an observer perceives an image having one color.

Since the field sequential display device sequentially generates the red light, green light and blue light so that an observer perceives the image having one color, it does not simultaneously mix the red light, green-light and blue light. Thus, a color break results when the field sequential display device is physically shielded or displays an object moving at a high speed.

When a scanning frequency of a conventional display device is about 60 Hz, a scanning frequency of the field sequential display device is about 180 Hz, which is relatively high for the conventional display device. However, 180 Hz is relatively low for the field sequential display device.

Thus, the color break is an often occurrence in the field sequential display device due to the low scanning frequency.

### BRIEF SUMMARY OF THE INVENTION

Aspects of present invention provide a display panel and a display device having the display panel capable of effectively preventing and/or substantially reducing a color break.

In one exemplary embodiment of the present invention, a display panel includes a plurality of gate lines, a plurality of source lines crossing the gate lines, a first integration gate line, a first pixel part, a second pixel part and a third pixel part. The first integration gate line integrates a (6K−5)-th gate line, a (6K−3)-th gate line and a (6K−1)-th gate line, wherein K is a natural number. The first pixel part, the second pixel part and the third pixel part are arranged in a same column. The first pixel part is driven by a first switching device electrically connected to the (6K−5)-th gate line and a (3K−2)-th source line. The second pixel part is driven by a second switching device electrically connected to the (6K−3)-th gate line and a (3K−1)-th source line. The third pixel part is driven by a third switching device electrically connected to the (6K−1)-th gate line and a 3K-th source line.

The display panel may further include a second integration gate line, a fourth pixel part, a fifth pixel part and a sixth pixel part. The second integration gate line integrates a (6K−4)-th gate line, a (6K−2)-th gate line and a 6K-th gate line. The fourth pixel part is driven by a fourth switching device electrically connected to the (6K−4)-th gate line and the (3K−2)-th source line. The fifth pixel part is driven by a fifth switching device electrically connected to the (6K−2)-th gate line and the (3K−1)-th source line. The sixth pixel part is driven by a sixth switching device electrically connected to the 6K-th gate line and the 3K-th source line. The first, second, third, fourth, fifth and sixth pixel parts are arranged in a same column.

In another exemplary embodiment of the present invention, a display device includes a display panel, a gate driving part and a source driving part. The display panel includes a plurality of gate lines, a plurality of source lines crossing the gate lines, a first integration gate line and a second first integration line. The first integration gate line integrates a (6K−5)-th gate line, a (6K−3)-th gate line and a (6K−1)-th gate line. The second integration gate line integrates a (6K−4)-th gate line, a (6K−2)-th gate line and a 6K-th gate line. K is a natural number. The gate driving part sequentially provides the first and second integration gate line with a first integration gate signal and a second integration gate signal. The source driving part provides the source lines with data signals.

A frame is divided into a first field, a second field and a third field. The source driving part provides the source lines with a first color data signal and a first additional signal in the first field, and provides the source lines with a second color data signal and a second additional signal in the second field, and provides the source lines with a third color data signal and a third additional signal in the third field.

The display device may further include a light source part to sequentially generate a first light in the first field, a second light in the second field and a third light in the third field.

According to the above, a display device may be driven at a relatively high speed so that an additional signal is interposed between data signals. Thus, a color break may be effectively prevented and/or substantially reduced.

### BRIEF DESCRIPTION OF THE DRAWINGS

The above and other aspects, features and advantages of the present invention will become readily apparent by reference to the following detailed description when considered in conjunction with the accompanying drawings wherein:

FIG. 1 is a block diagram illustrating a display device according to an exemplary embodiment of the present invention;

FIG. 2 is a perspective view illustrating a light source part illustrated in FIG. 1 according to the exemplary embodiment of the present invention;

FIG. 3 is a schematic view illustrating a driving method of the display device illustrated in FIG. 1.

FIG. 4 is a plan view illustrating pixel parts of the display panel illustrated in FIG. 1;

FIG. 5 is a timing diagram illustrating gate signals applied to the display panel illustrated in FIG. 4;

FIG. 6 is a timing diagram illustrating driving signals for driving the display panel illustrated in FIG. 4;

FIG. 7 is a plan view illustrating pixel parts of a display panel according to another exemplary embodiment of the present invention; and

FIG. 8 is a timing diagram illustrating driving signals for driving the display panel illustrated in FIG. 7.

### DETAILED DESCRIPTION OF THE INVENTION

The present invention is described more fully hereinafter with reference to the accompanying drawings, in which exemplary embodiments of the invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,”

“directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

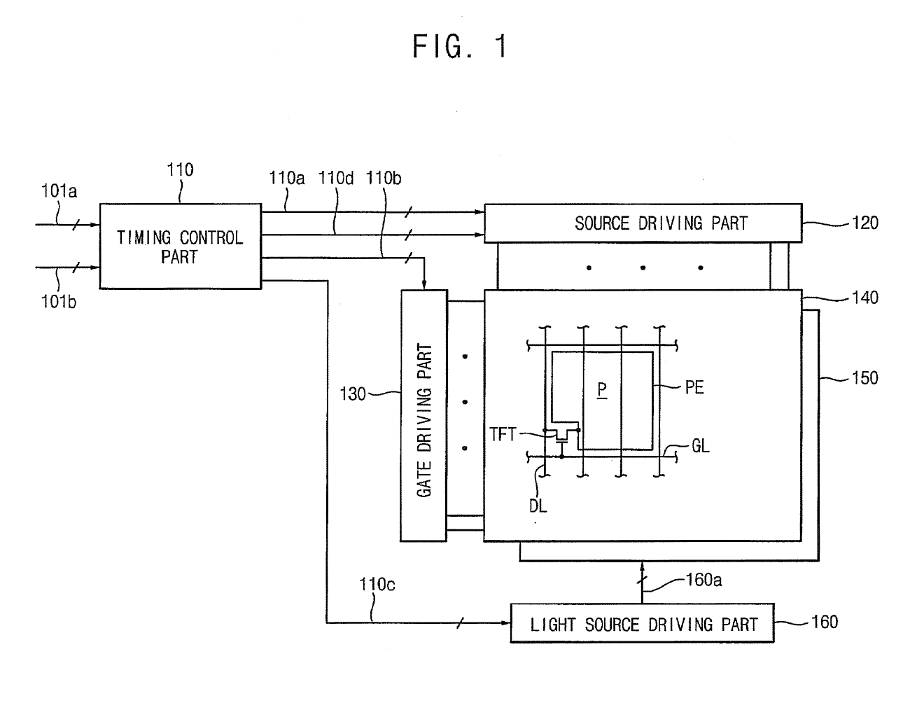

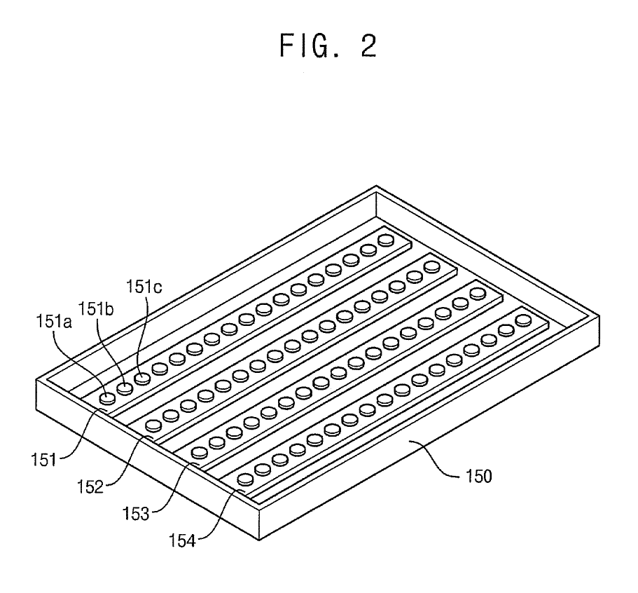

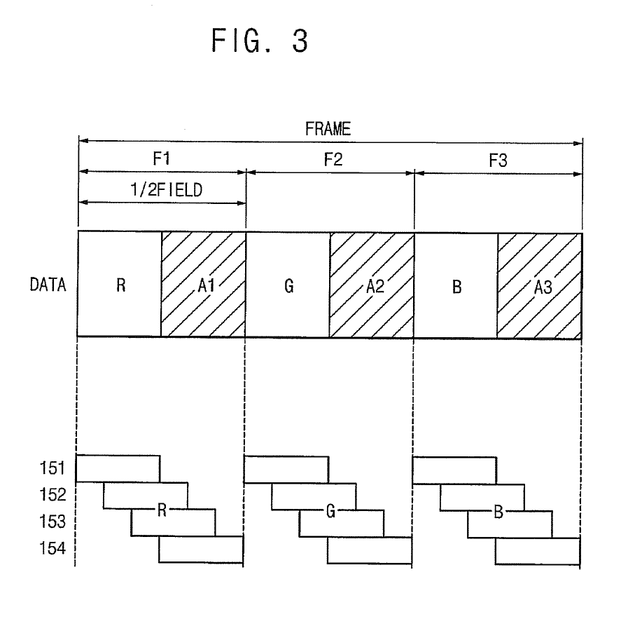

FIG. 1 is a block diagram illustrating a display device according to an exemplary embodiment of the present invention. FIG. 2 is a perspective view illustrating a light source part illustrated in FIG. 1. FIG. 3 is a schematic view illustrating a driving method of the display device illustrated in FIG. 1.

Referring to FIGS. 1 to 3, a display device includes a timing control part 110, a source driving part 120, a gate driving part 130, a display panel 140, a light source part 150 and a light source driving part 160.

A timing control signal 101a and a data signal 101b are applied to the timing control part 110 from an external device (not shown). The timing control part 110 outputs control signals to drive the display device in response to the timing control signal 101a. For example, the timing control part 110 may output a first control signal 110a to control the source driving part 120, a second control signal 110b to control the gate driving part 130 and a third control signal 110c to control the light source driving part 150.

The source driving part 120 converts a data signal 110d to an analog data voltage in response to the first control signal 110a applied to the source driving part 120 from the timing control part 110, and provides the display panel 140 with the converted data signal 110d. The first control signal 110a includes a data enable signal, of which a cycle is a horizontal period.

Referring to FIG. 3, the source driving part 120 divides a frame into a first field F1, a second field F2 and a third field F3. Particularly, the source driving part 120 outputs a first color data signal R and a first additional signal A1 in the first field F1, a second color data signal G and a second additional signal A2 in the second field F2 and a third color data signal B and a third additional signal A3 in the third field F3. For example, the first additional signal A1 may be a gray scale signal between the first and second color data signals R and G, and the second additional signal A2 may be a gray scale signal between the second and third color data signals G and B, and the third additional signal A3 may be a gray scale signal between the third color data signal B and the first color data signal R of a next frame.

The gate driving part 130 generates a gate signal to provide the display panel 140 with the gate signal in response to the second control signal 110b. The gate driving part 130 outputs two gate signals for one horizontal period. Thus, a driving speed of the gate driving part 130 is twice a driving speed of a gate driving part outputting only one gate signal for the horizontal period.

The display panel 140 has a plurality of pixel parts P defined by a plurality of gate lines GL and a plurality of source lines DL. A pixel electrode PE is formed in three pixel areas defined by one of the gate lines GL and three of the source lines DL to define one pixel part R The light source part 150 includes a first block 151, a second block 152, a third block 153 and a fourth block 154. The first, second, third and fourth blocks 151, 152, 153 and 154 are sequentially driven by a predetermined time gap. Alternatively, the light source may have eight blocks instead of the four illustrated in FIG. 2. Particularly, the first block 151 has a plurality of light-generating devices. The light-generating devices include a first light-generating device 151a generating a first light, a second light-generating device 151b generating a second light and a third light-generating device 151c generating a third light. The first, second and third light-generating devices 151a, 151b and 151c are time-divided to sequentially generate the first, second and third lights, respectively.

The light source driving part 160 sequentially drives the first, second and third light-generating devices 151a, 151b and 151c in response to the third control signal 110c applied to the light source driving part 160 from the timing control part 110.

Referring to FIG. 3, the light source driving part 160 sequentially drives the first light-generating devices 151a of the first, second, third and fourth blocks 151, 152, 153 and 154, and sequentially drives the second light-generating devices 151b of the first, second, third and fourth blocks 151, 152, 153 and 154, and sequentially drives the third light-generating devices 151c of the first, second, third and fourth blocks 151, 152, 153 and 154. Thus, the light source part 150 sequentially emits the first light in the first field F1, the second light in the second field F2 and the third light in the third field F3 toward the display panel 140. Thus, the display panel 140 sequentially displays a first color image, a first additional image, a second color image, a second additional image, a third color image and a third additional image in the frame, thus effectively preventing or substantially reducing a color break in the frame.

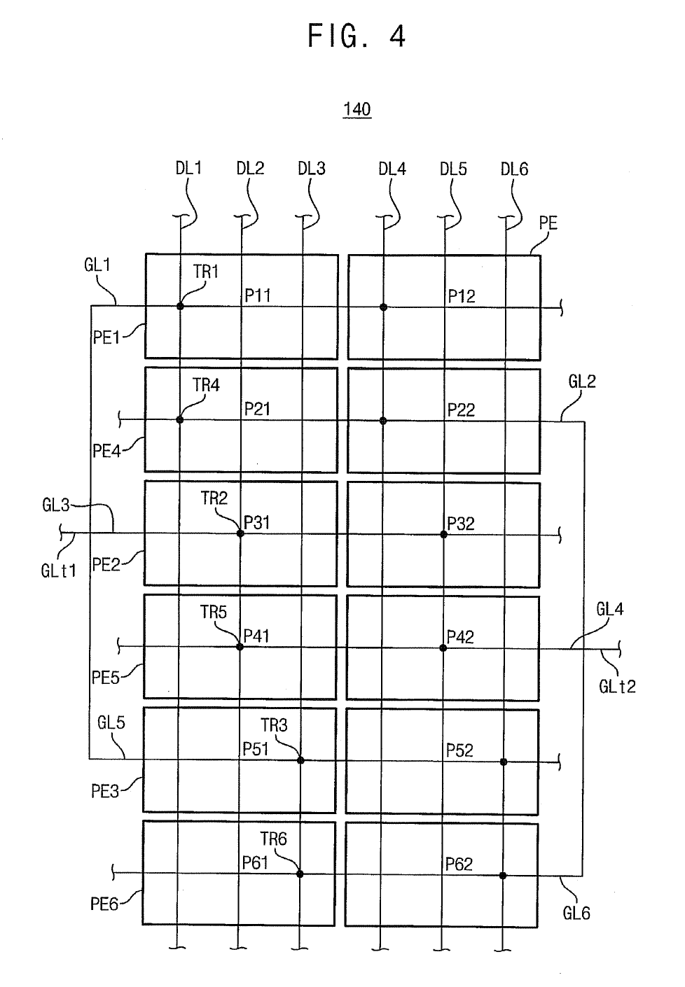

FIG. 4 is a plan view illustrating pixel parts P of the display panel 140 illustrated in FIG. 1.

Referring to FIGS. 1 and 4, a display panel 140 includes a plurality of gate lines GL1, GL2, GL3, GL4, GL5 and GL6 and a plurality of source lines DL1, DL2, DL3, DL4, DL5 and DL6.

Particularly, a (6K−5)-th gate line GL1, a (6K−3)-th gate line GL3 and a (6K-1)-th gate line GL5 are integrated into a first integration gate line GLt1. A (6K−4)-th gate line GL2, a (6K−2)-th gate line GL4 and a 6K-th gate line GL6 are integrated into a second integration gate line GLt2. Here, K is a natural number.

A first pixel part P11, a second pixel part P31, a third pixel part P51, a fourth pixel part P21, a fifth pixel part P41 and a sixth pixel part P61 are defined in a first column by the (6K−5)-th, (6K−4)-th, (6K−3)-th, (6K−2)-th, (6K−1)-th and 6K-th gate lines GL1, GL2, GL3, GL4, GL5 and GL6 and a first source line DL1, a second source line DL2 and a third source line DL3. Furthermore, a first pixel part P12, a second pixel part P32, a third pixel part P52, a fourth pixel part P22, a fifth pixel part P42 and a sixth pixel part P62 are defined in a second column adjacent to the first column by the (6K−5)-th, (6K−4)-th, (6K−3)-th, (6K−2)-th, (6K−1)-th and 6K-th gate lines GL1, GL2, GL3, GL4, GL5 and GL6 and a fourth source line DL4, a fifth source line DL5 and a sixth source line DL6.

In the first column, the first pixel part P11 includes a first switching device TR1 and a first liquid crystal capacitor. The first switching device TR1 is electrically connected to the (6K−5)-th gate line GL1 and a (3K−2)-th source line DL1. A first electrode of the first liquid crystal capacitor is defined as a first pixel electrode PE1 electrically connected to the first switching device TR1. The second pixel part P31 includes a second switching device TR2 and a second liquid crystal capacitor. The second switching device TR2 is electrically connected to the (6K−3)-th gate line GL3 and a (3K−1)-th source line DL2. A first electrode of the second liquid crystal capacitor is defined as a second pixel electrode PE2 electrically connected to the second switching device TR2. The third pixel part P51 includes a third switching device TR3 and a third liquid crystal capacitor. The third switching device TR3 is electrically connected to the (6K−1)-th gate line GL5 and a 3K-th source line DL3. A first electrode of the third liquid crystal capacitor is defined as a third pixel electrode PE3 electrically connected to the third switching device TR3.

The fourth pixel part P21 includes a fourth switching device TR4 and a fourth liquid crystal capacitor. The fourth switching device TR4 is electrically connected to the (6K−4)-th gate line GL2 and the (3K−2)-th source line DL1. A first electrode of the fourth liquid crystal capacitor is defined as a fourth pixel electrode PE4 electrically connected to the fourth switching device TR4. The fifth pixel part P41 includes a fifth switching device TR5 and a fifth liquid crystal capacitor. The fifth switching device TR5 is electrically connected to the (6K−2)-th gate line GL4 and the (3K−1)-th source line DL2. A first electrode of the fifth liquid crystal capacitor is defined as a fifth pixel electrode PE5 electrically connected to the fifth switching device TR5. The sixth pixel part P61 includes a sixth switching device TR6 and a sixth liquid crystal capacitor. The sixth switching device TR6 is electrically connected to the 6K-th gate line GL6 and the 3K-th source line DL3. A first electrode of the sixth liquid crystal capacitor is defined as a sixth pixel electrode PE6 electrically connected to the sixth switching device TR6.

A first integration gate signal is applied to the first integration gate line GLt1 for the former half of one horizontal period to activate the (6K−5)-th, (6K−3)-th, (6K−1)-th gate lines GL1, GL3 and GL5, respectively. A second integration gate signal is applied to the second integration line GLt2 for the latter half of the horizontal period to activate the (6K−4)-th, (6K−2)-th and 6K-th gate lines GL2, GL4 and GL6, respectively.

Data signals corresponding to the pixel parts P11, P12, P31, P32, P51 and P52 electrically connected to the (6K−5)-th, (6K−3)-th, (6K−1)-th gate lines GL1, GL3 and GL5, respectively, are applied to the (3K−2)-th, (3K−1)-th and 3K-th source lines for the former half of the horizontal period. Furthermore, data signals corresponding to the pixel parts P21, P22, P41, P42, P61 and P62 electrically connected to the (6K−4)-th, (6K−2)-th and 6K-th gate lines GL2, GL4 and GL6, respectively, are applied to the (3K−2)-th, (3K−1)-th and 3K-th source lines for the latter half of the horizontal period.

Thus, all of the pixel parts P11, P12, P31, P32, P51, P52, P21, P22, P41, P42, P61 and P62 electrically connected to the (6K−5)-th, (6K−4)-th, (6K−3)-th, (6K−2)-th, (6K−1)-th and 6K-th gate lines GL1, GL2, GL3, GL4, GL5 and GL6 are driven for the horizontal period.

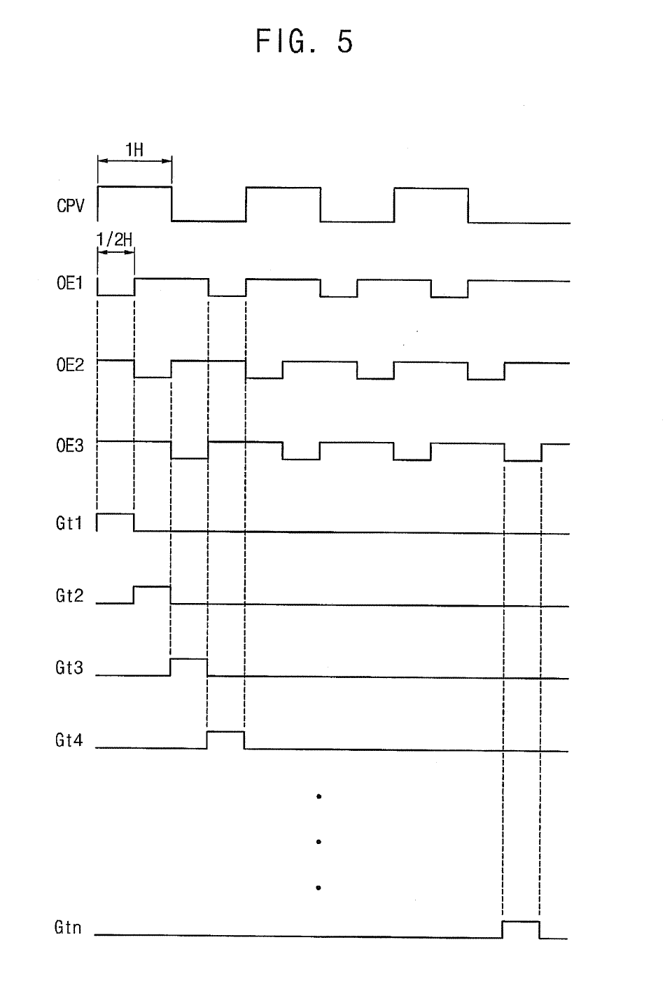

FIG. 5 is a timing diagram illustrating gate signals applied to the display panel 140 illustrated in FIG. 4.

Referring to FIGS. 1, 4 and 5, the gate driving part 130 outputs a plurality of integration gate signals Gt1, Gt2, . . . , Gtn−1, Gtn based on the second control signal 110b. The integration gate signals Gt1, Gt2, . . . , Gtn−1, Gtn are applied to a plurality of integration gate lines including the first and second integration gate lines GLt1 and GLt2.

Particularly, the second control signal 110b includes a scan clock signal CPV, a first output enable signal OE1, a second output enable signal OE2 and a third output enable signal OE3. (3K−2)-th integration gate signals Gt1, Gt4, . . . are outputted in response to the first output enable signal OE1. (3K−1)-th integration gate signals Gt2, Gt5, . . . are outputted in response to the second output enable signal OE2. 3K-th integration gate signals Gt3, Gt6, . . . are outputted in response to the third output enable signal OE3.

Each of the first, second and third output enable signals OE1, OE2 and OE3 has a control period C corresponding to a half ½H of one horizontal period 1H. Each of the integration gate signals Gt1, Gt2, . . . , Gtn−1, Gtn has a pulse width corresponding to the control period C. Particularly, the control period C of each of the first, second and third output enable signals OE1, OE2 and OE3 is adjusted so that the pulse width of each of the integration gate signals Gt1, Gt2, . . . , Gtn−1, Gtn is a half of one horizontal period 1H (e.g., ½H). Thus, the integration gate signals activate the first and second integration gate lines GLt1 and GLt2 for one horizontal period.

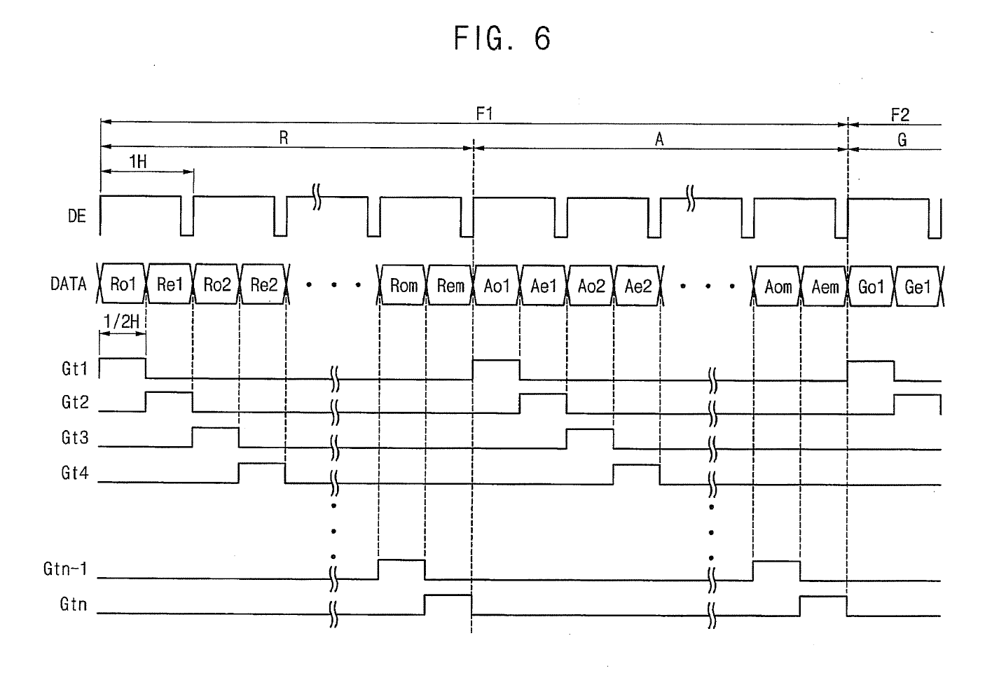

FIG. 6 is a timing diagram illustrating driving signals for driving the display panel 140 illustrated in FIG. 4. A driving method of the display panel in a first field F1 will be described hereinafter.

Referring to FIGS. 1, 3, 4 and 6, the gate driving part 130 provides the first integration gate line GLt1 with the first integration gate signal Gt1 for the former half of one horizontal period 1H. Thus, the (6K−5)-th, (6K−3)-th, (6K−1)-th gate lines GL1, GL3 and GL5, respectively, are simultaneously activated.

The source driving part 120 is synthesized with the data enable signal DE to output an odd red data Ro1 driving the pixel parts P11, P12, P31, P32, P51 and P52 electrically connected to the (6K−5)-th, (6K−3)-th and (6K−1)-th gate lines GL1, GL3 and GL5, respectively, for the former half of the horizontal period 1H. Particularly, the source driving part 120 provides the (3K−2)-th source lines DL1 and DL4 with a red data R to drive the pixel parts P11 and P12 electrically connected to the (6K−5)-th gate line GL1, and provides the (3K−1)-th source lines DL2 and DL5 with a red data R to drive the pixel parts P31 and P32 electrically connected to the (6K−3)-th gate line GL3, and provides the 3K-th source lines DL3 and DL6 with a red data R to drive the pixel parts P51 and P52 electrically connected to the (6K−1)-th gate line GL5.

The gate driving part 130 provides the second integration gate line GLt2 with the second integration gate signal Gt2 for the latter half of the horizontal period 1H. Thus, the (6K−4)-th, (6K−2)-th and 6K-th gate lines GL2, GL4 and GL6, respectively, are simultaneously activated.

The source driving part 120 is synthesized with the data enable signal DE to output an even red data Re1 driving the pixel parts electrically connected to the (6K−4)-th, (6K−2)-th and 6K-th gate lines GL2, GL4 and GL6, respectively, for the latter half of the horizontal period. Particularly, the source driving part 120 provides the (3K−2)-th source lines DL1 and DL4 with a red data R to drive the pixel parts P21 and P22 electrically connected to the (6K−4)-th gate line GL2, and provides the (3K−1)-th source lines DL2 and DL5 with a red data R to drive the pixel parts P41 and P42 electrically connected to the (6K−2)-th gate line GL4, and provides the 3K-th source lines DL3 and DL6 with a red data R to drive the pixel parts P61 and P62 electrically connected to the 6K-th gate line GL6.

Thus, the pixel parts electrically connected to the (6K−5)-th, (6K−4)-th, (6K−3)-th(6K−2)-th, (6K−1)-th and 6K-th gate lines GL1, GL2, GL3, GL4, GL5 and GL6, respectively, are driven to display the red data R. As described above, the red data R of one frame is displayed for a half of the first field F1.

An additional data A is displayed for a remaining half of the first field F1 to prevent a color break. The additional data A corresponds to a gray scale between the red data R and a green data G displayed in the second field F2.

A method of displaying the additional data A is substantially the same as the method of displaying the red data R described above. Particularly, an odd additional data Ao1 is displayed in the pixel parts electrically connected to the (6K−5)-th, (6K−3)-th and (6K−1)-th gate lines GL1, GL3 and GL5 respectively, for the former half of the horizontal period. An even additional data Ae1 is displayed in the pixel parts electrically connected to the (6K−4)-th, (6K−2)-th and 6K-th gate lines GL2, GL4 and GL6, respectively, for the latter half of the horizontal period.

As in the above described method, the green data G and an additional data A2 are displayed in the second field F2, and a blue data and an additional data A3 are displayed in the third field F3.

Thus, in this exemplary embodiment, the (6K−5)-th, (6K−3)-th and (6K−1)-th gate lines GL1, GL3 and GL5, respectively are integrated into a first group, and the (6K−4)-th, (6K−2)-th and 6K-th gate lines GL2, GL4 and GL6, respectively, are integrated into a second group to display a red data for a first period of the first field. Furthermore, an additional data is displayed for a second period of the first field, thus effectively preventing and/or substantially reducing a color break in the frame.

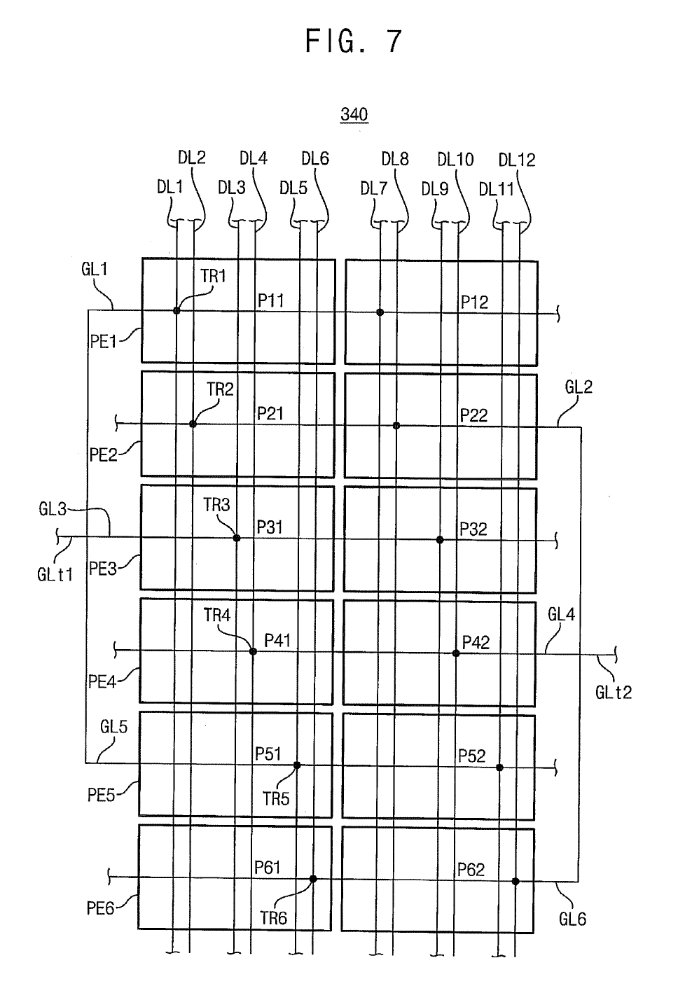

FIG. 7 is a plan view illustrating pixel parts of a display panel according to another exemplary embodiment of the present invention.

Referring to FIG. 7, a display panel 340 includes a plurality of gate lines GL1, GL2, GL3, GL4, GL5 and GL6 and a plurality of source lines DL1, DL2, DL3, DL4, DL5, DL6, DL7, DL8, DL9, DL10, DL11 and DL12.

Particularly, a (6K−5)-th gate line GL1, a (6K−3)-th gate line GL3 and a (6K−1)-th gate line GL5 are integrated into a first integration gate line GLt1. A (6K−4)-th gate line GL2, a (6K−2)-th gate line GL4 and a 6K-th gate line GL6 are integrated into a second integration gate line GLt2. Here, K is a natural number.

A first pixel part P11, a second pixel part P21, a third pixel part P31, a fourth pixel part P41, a fifth pixel part P51 and a sixth pixel part P61 are defined in a first column by the (6K−5)-th, (6K−4)-th, (6K−3)-th, (6K−2)-th, (6K−1)-th and 6K-th gate lines GL1, GL2, GL3, GL4, GL5 and GL6, respectively, and a first source line DL1, a second source line DL2, a third source line DL3, a fourth source line DL4, a fifth source line DL5 and a sixth source line DL6. Furthermore, a first pixel part P12, a second pixel part P22, a third pixel part P32, a fourth pixel part P42, a fifth pixel part P52 and a sixth pixel part P62 are defined in a second column adjacent to the first column by the (6K−5)-th, (6K−4)-th, (6K−3)-th, (6K−2)-th, (6K−1)-th and 6K-th gate lines GL1, GL2, GL3, GL4, GL5 and GL6, respectively, and a seventh source line DL7, an eighth source line DL8, a ninth source line DL9, a tenth source line DL10, an eleventh source line DL11 and a twelfth source line DL12.

In the first column, the first pixel part P11 includes a first switching device TR1 and a first liquid crystal capacitor. The first switching device TR1 is electrically connected to the (6K−5)-th gate line GL1 and a (6K−5)-th source line DL1. A first electrode of the first liquid crystal capacitor is defined as a first pixel electrode PE1 electrically connected to the first switching device TR1. The second pixel part P21 includes a second switching device TR2 and a second liquid crystal capacitor. The second switching device TR2 is electrically connected to the (6K−4)-th gate line GL2 and a (6K−4)-th source line DL2. A first electrode of the second liquid crystal capacitor is defined as a second pixel electrode PE2 electrically connected to the second switching device TR2. The third pixel part P31 includes a third switching device TR3 and a third liquid crystal capacitor. The third switching device TR3 is electrically connected to the (6K−3)-th gate line GL3 and a (6K−3)-th source line DL3. A first electrode of the third liquid crystal capacitor is defined as a third pixel electrode PE3 electrically connected to the third switching device TR3.

The fourth pixel part P41 includes a fourth switching device TR4 and a fourth liquid crystal capacitor. The fourth switching device TR4 is electrically connected to the (6K−2)-th gate line GL4 and the (6K−2)-th source line DL4. A first electrode of the fourth liquid crystal capacitor is defined as a fourth pixel electrode PE4 electrically connected to the fourth switching device TR4. The fifth pixel part P51 includes a fifth switching device TR5 and a fifth liquid crystal capacitor. The fifth switching device TR5 is electrically connected to the (6K−1)-th gate line GL5 and the (6K−1)-th source line DL5. A first electrode of the fifth liquid crystal capacitor is defined as a fifth pixel electrode PE5 electrically connected to the fifth switching device TR5. The sixth pixel part P61 includes a sixth switching device TR6 and a sixth liquid crystal capacitor. The sixth switching device TR6 is electrically connected to the 6K-th gate line GL6 and the 6K-th source line DL6. A first electrode of the sixth liquid crystal capacitor is defined as a sixth pixel electrode PE6 electrically connected to the sixth switching device TR6.

A first integration gate signal is applied to the first integration gate line GLt1 for the former half of one horizontal period to activate the (6K−5)-th, (6K−3)-th and (6K−1)-th gate lines GL1, GL3 and GL5, respectively. A second integration gate signal is applied to the second integration line GLt2 for the latter half of the horizontal period to activate the (6K−4)-th, (6K−2)-th 6K-th gate lines GL2, GL4 and GL6, respectively.

Furthermore, data signals are applied to the (6K−5)-th, (6K−4)-th, (6K−3)-th, (6K−2)-th, (6K−1)-th and 6K-th source lines DL1, DL2, DL3, DL4, DL5 and DL6, respectively, for the horizontal period.

Thus, the (6K−5)-th, (6K−3)-th and (6K−1)-th gate lines GL1, GL3 and GL5, respectively, are activated by the first integration gate signal to drive the pixel parts P11, P12, P31, P32, P51 and P52 corresponding to the (6K−5)-th, (6K−3)-th and (6K−1)-th gate lines GL1, GL3 and GL5, respectively. Furthermore, the (6K−4)-th, (6K−2)-th and 6K-th gate lines GL2, GL4 and GL6, respectively, are activated by the second integration gate signal to drive the pixel parts P21, P22, P41, P42, P61 and P62 corresponding to the (6K−4)-th, (6K−2)-th and 6K-th gate lines GL2, GL4 and GL6, respectively. Thus, all of the pixel parts P11, P12, P31, P32, P51, P52, P21, P22, P41, P42, P61 and P62 corresponding to the (6K−5)-th, (6K−4)-th, (6K−3)-th, (6K−2)-th, (6K−1)-th and 6K-th gate lines GL1, GL2, GL3, GL4, GL5 and GL6, respectively, are driven.

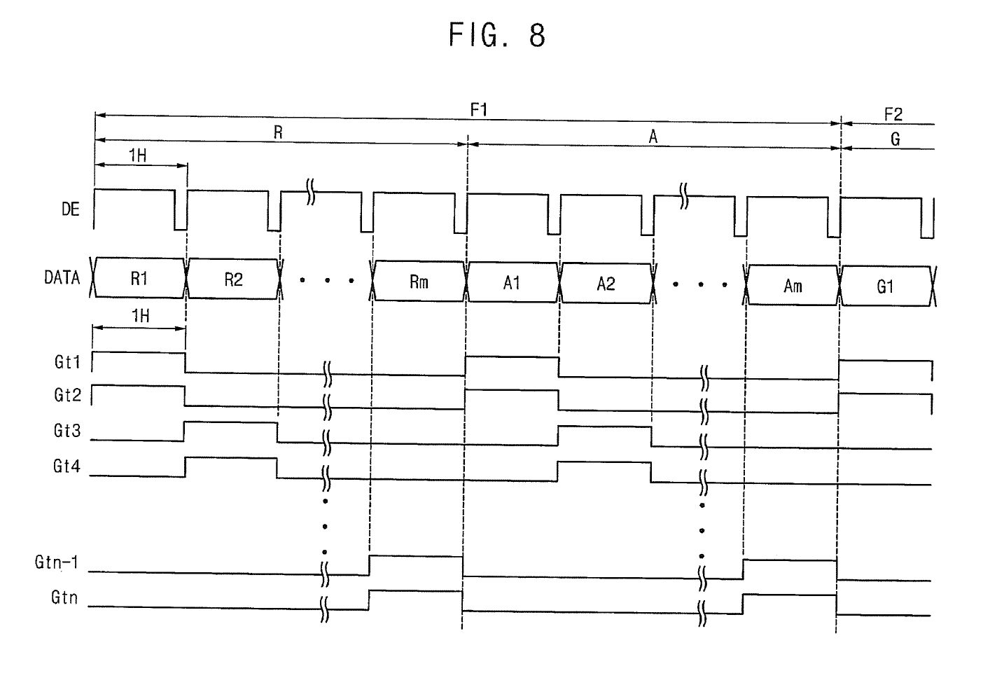

FIG. 8 is a timing diagram illustrating driving signals for driving the display panel illustrated in FIG. 7. A driving method in a first field F1 will be explained hereinafter.

Referring to FIGS. 1, 7 and 8, the gate driving part 130 provides the first integration gate line GLt1 with the first integration gate signal Gt1, and provides the second integration gate line GLt2 with the second integration gate signal Gt2 for one horizontal period. Each of the first and second integration gate signals Gt1 and Gt2 has a pulse width corresponding to the horizontal period, as illustrated in FIG. 8.

Thus, the (6K−5)-th, (6K−4)-th, (6K−3)-th, (6K−2)-th, (6K−1)-th and 6K-th gate lines GL1, GL2, GL3, GL4, GL5 and GL6, respectively, are simultaneously activated.

The source driving part 120 is synthesized with the data enable signal DE to provide the first, second, third, fourth, fifth and sixth source lines DL1, DL2, DL3, DL4, DL5 and DL6 with a red data R driving the first, second, third, fourth, fifth and sixth pixel parts P11, P21, P31, P41, P51 and P61 in the first column, and to provide the seventh, eighth, ninth, tenth, eleventh and twelfth source lines DL7, DL8, DL9, DL10, DL11 and DL12 with a red data R driving the first, second, third, fourth, fifth and sixth pixel parts P12, P22, P32, P42, P52 and P62 in the second column. Particularly, the source driving part 120 outputs the red data R to drive the pixel parts P11, P12, P31, P32, P51, P52, P21, P22, P41, P42, P61 and P62 corresponding to the (6K−5)-th, (6K−4)-th, (6K−3)-th, (6K−2)-th, (6K−1)-th and 6K-th gate lines GL1, GL2, GL3, GL4, GL5 and GL6, respectively. As described above, the red data R of one frame is displayed for a half of the first field F1.

An additional data A is displayed for a remaining half of the first field F1 to prevent a color break. The additional data A corresponds to a gray scale between the red data R and a green data G displayed in the second field F2.

Thus, in the present exemplary embodiment, the (6K−5)-th, (6K−3)-th and (6K−1)-th gate lines GL1, GL3 and GL5, respectively, are integrated into a first group, and the (6K−4)-th, (6K−2)-th and 6K-th gate lines GL2, GL4 and GL6, respectively, are integrated into a second group to display a red data for a first period of the first field. Furthermore, an additional data is displayed for a second period of the first field, thus effectively preventing and/or substantially reducing a color break.

According to the above, a (6K−5)-th gate line, a (6K−3)-th gate line and a (6K-1)-th gate line are integrated into a first group, and a (6K−4)-th gate line, a (6K−2)-th gate line and a 6K-th gate line are integrated into a second group so that the (6K−5)-th, (6K−4)-th, (6K−3)-th, (6K−2)-th, (6K−1)-th and 6K-th gate lines are driven at a relatively high speed. Thus, a first color image, a first additional image, a second color image, a second additional image, a third color image and a third additional image are displayed in one frame. Therefore, a color break may be effectively prevented and/or substantially reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display panel comprising:
a plurality of gate lines;
a plurality of source lines crossing the gate lines;
a first integration gate line integrating a (6K−5)-th gate line, a (6K−3)-th gate line and a (6K−1)-th gate line of the plurality of gate lines, wherein K is a natural number; and
first, second and third pixel parts arranged in a same column, the first pixel part being driven by a first switching device electrically connected to the (6K−5)-th gate line and a (3K−2)-th source line, the second pixel part being driven by a second switching device electrically connected to the (6K−3)-th gate line and a (3K−1)-th source line, the third pixel part being driven by a third switching device electrically connected to the (6K−1)-th gate line and a 3K-th source line of the plurality of source lines.

2. The display panel of claim 1, further comprising:
a second integration gate line to integrate a (6K−4)-th gate line, a (6K−2)-th gate line and a 6K-th gate line of the plurality of gate lines;
a fourth pixel part being driven by a fourth switching device electrically connected to the (6K−4)-th gate line and the (3K−2)-th source line;
a fifth pixel part being driven by a fifth switching device electrically connected to the (6K−2)-th gate line and the (3K−1)-th source line; and
a sixth pixel part being driven by a sixth switching device electrically connected to the 6K-th gate line and the 3K-th source line.

3. The display panel of claim 2, wherein the first, second, third, fourth, fifth and sixth pixel parts are arranged in a same column.

4. A display device comprising:
a display panel comprising a plurality of gate lines, a plurality of source lines crossing the gate lines, a first integration gate line to integrate a (6K−5)-th gate line, a (6K−3)-th gate line and a (6K−1)-th gate line and a second integration gate line to integrate a (6K−4)-th gate line, a (6K−2)-th gate line and a 6K-th gate line of the plurality of gate lines, wherein K is a natural number;
a gate driving part to sequentially provide the first and second integration gate lines with a first integration gate signal and a second integration gate signal, respectively; and
a source driving part to provide the source lines with data signals.

5. The display device of claim 4, wherein a frame is divided into a first field, a second field and a third field, and the source driving part provides the source lines with a first color data signal and a first additional signal in the first field, provides the source lines with a second color data signal and a second additional signal in the second field, and provides the source lines with a third color data signal and a third additional signal in the third field.

6. The display device of claim 5, further comprising a light source part to sequentially generate a first light in the first field, a second light in the second field and a third light in the third field.

7. The display device of claim 5, wherein the first additional signal is a gray scale signal between the first color data signal and the second color data signal, and the second additional signal is a gray scale signal between the second color data signal and the third color data signal, and the third additional signal is a gray scale signal between the third color data signal and the first color data signal of a next frame.

8. The display device of claim 4, further comprising
a first pixel part electrically connected to the (6K−5)-th gate line and a (3K−2)-th source line of the plurality of source lines;
a second pixel part electrically connected to the (6K−3)-th gate line and a (3K−1)-th source line of the plurality of source lines;
a third pixel part electrically connected to the (6K−1)-th gate line and a 3K-th source line of the plurality of source lines;
a fourth pixel part electrically connected to the (6K−4)-th gate line and the (3K−2)-th source line of the plurality of source lines;
a fifth pixel part electrically connected to the (6K−2)-th gate line and the (3K−1)-th source line of the plurality of source lines; and
a sixth pixel part electrically connected to the 6K-th gate line and the 3K-th source line of the plurality of source lines,
wherein the first, second, third, fourth, fifth and sixth pixel parts are arranged in a same column.

9. The display device of claim 8, wherein the first integration gate signal activates the (6K−5)-th, (6K−3)-th and (6K−1)-th gate lines for a former half of one horizontal period, and the second integration gate signal activates the (6K−4)-th, (6K−2)-th and 6K-th gate lines for a latter half of the horizontal period.

10. The display device of claim 9, wherein the source driving part provides the (3K−2)-th, (3K−1)-th and 3K-th source lines with color signals corresponding to the first, second and third pixel parts for the former half of the horizontal period, and provides the (3K−2)-th, (3K−1)-th and 3K-th source lines with color signals corresponding to the fourth, fifth and sixth pixel parts for the latter half of the horizontal period.

11. The display device of claim 4, further comprising:
a first pixel part electrically connected to the (6K−5)-th gate line and a (6K−5)-th source line of the plurality of source lines;
a second pixel part electrically connected to the (6K−4)-th gate line and a (6K−4)-th source line of the plurality of source lines;
a third pixel part electrically connected to the (6K−3)-th gate line and a (6K−3)-th source line of the plurality of source lines;
a fourth pixel part electrically connected to the (6K−2)-th gate line and a (6K−2)-th source line of the plurality of source lines;
a fifth pixel part electrically connected to the (6K−1)-th gate line and a (6K−1)-th source line of the plurality of source lines; and
a sixth pixel part electrically connected to the 6K-th gate line and a 6K-th source line of the plurality of source lines,
wherein the first, second, third, fourth, fifth and sixth pixel parts are arranged in a same column.

12. The display device of claim 11, wherein the first integration gate signal activates the (6K−5)-th, (6K−3)-th and (6K−1)-th gate lines for one horizontal period, and the second integration gate signal activates the (6K−4)-th, (6K−2)-th and 6K-th gate lines for the horizontal period.

13. The display device of claim 12, wherein the source driving part outputs color signals corresponding to the first, second, third, fourth, fifth and sixth pixel parts for the horizontal period.
